(19) United States
(12) Patent Application Publication
(10) Pub. No.: US 2021/0152107 A1
(43) Pub. Date: May 20, 2021

(54) ROBOT, AND MICRO CONTROL UNIT AND METHOD FOR CALIBRATING THE ANGULAR VELOCITY OF A MOTOR THEREOF

(71) Applicant: Institute For Information Industry, Taipei (TW)

(72) Inventor: Chi-Hong WU, Taipei (TW)

(21) Appl. No.: 16/702,526

(22) Filed: Dec. 3, 2019

(30) Foreign Application Priority Data
Nov. 14, 2019 (TW) 108141398

(51) Int. Cl. H02P 6/06; H02P 6/17; B25J 9/16

(52) U.S. Cl. CPC H02P 6/06; B25J 9/1692; H02P 6/17

(57) ABSTRACT

A body of a robot includes a motor and a driver. A micro control unit (MCU) is configured in the motor, and it senses a magnetic field of a rotor of the motor and generates two voltage signals. Then, the MCU receives a pulse signal from the driver, and calculates an ideal angular velocity of the rotor according to the pulse signal. In addition, the MCU calculates a current angular velocity of the rotor based on the voltage signals. Next, the MCU transmits a calibration signal to a pulse width-modulation (PWM) amplifier of the motor according to the difference between the current angular velocity and the ideal angular velocity so that the pulse width modulation amplifier calibrates the current angular velocity of the rotor according to the calibration signal, thereby adjusts an action of the robot.

### PRIORITY

This application claims priority to Taiwan Patent Application No. 108141398 filed on Nov. 14, 2019, which is hereby incorporated by reference in its entirety.

### FIELD

The present disclosure relates to controlling a robot. More particularly, the present disclosure relates to a robot, and a method and a micro control unit (MCU) for calibrating the angular velocity of the robot's motor.

### BACKGROUND

Nowadays, many service robots can provide various services for persons in places such as restaurants, hotel lobbies, airports etc. A service robot can be controlled autonomously, or can also be controlled by a cloud editor provided by a cloud integration platform via transmitting commands, so that the service robot can perform various service actions. Since the service robot needs to be in close contact and interaction with a person, if the rotation control of its motor is not accurate enough, its movement speed may be slow or its movement position may be inaccurate, and thus it may not provide the person with satisfactory service and experience.

Conventional robots and the motors thereof generally perform rotation controls and rotation compensations with a driver and a pulse-width modulation (PWM) amplifier. More particularly, the driver determines the angular velocity of the rotor of the motor and control the rotation of the rotor (i.e., rotation control) with the PWM amplifier for different applications. In addition, when the driver detects a difference between a current angular velocity of the rotating rotor and the determined angular velocity, it may transmit a calibration signal to the PWM amplifier according to the difference so that the PWM amplifier adjusts the current angular velocity of the rotor according to the calibration signal (i.e., rotation compensation).

The driver of a motor is generally positioned outside the motor, and this causes the signal transmissions between the driver and the motor to be time-consuming. Thus, the driver is not able to perform an instant rotation compensation to the motor whenever a delay or an interruption occurs to the signal transmission. Besides the transmission delay between the driver and the motor, the transmission delay between the driver and a central control computer which is configured to control the driver for smart operations may also lower the efficiency of the motor's rotation compensation performed by the driver. The lower efficiency the motor's rotation compensation presents, the higher probability of abnormality the motor has. For example, under the circumstance that the motor is used to control a robot, if the driver of the motor is not able to perform an instant rotation compensation to the motor, the robot is likely to perform dangerous or meaningless actions as the current angular velocity of the rotor of the motor become incorrect. Therefore, it is essential to improve the efficiency of performing a rotation compensation to the motor.

### SUMMARY

Provided is a micro control unit (MCU) for calibrating an angular velocity of a motor. The MCU may be configured in the motor. The motor may comprise a pulse-width modulation (PWM) amplifier and a rotor, and the PWM amplifier may be electrically connected with a driver. The MCU may be electrically connected with the PWM amplifier and the driver respectively. The MCU may comprise two Hall sensors and a calibration module electrically connected with the two Hall sensors. The two Hall sensors may be configured to sense a magnetic field of the rotor and generate two voltage signals. The calibration module may be configured to receive a pulse signal from the driver, and calculate an ideal angular velocity of the rotor according to the pulse signal. Moreover, the calibration module may further be configured to calculate a current angular velocity of the rotor based on the two voltage signals, and transmit a calibration signal to the PWM amplifier according to a difference of the current angular velocity and the ideal angular velocity so that the PWM amplifier adjusts the current angular velocity of the rotor according to the calibration signal.

Also provided is a method for calibrating an angular velocity of a motor. The method may comprise:

sensing a magnetic field of a rotor of the motor and generating two voltage signals by an MCU configured in the motor;

receiving a pulse signal from a driver of the motor by the MCU;

calculating an ideal angular velocity of the rotor by the MCU according to the pulse signal;

calculating a current angular velocity of the rotor by the MCU based on the two voltage signals; and

transmitting a calibration signal from the MCU to a PWM amplifier of the motor according to a difference of the current angular velocity and the ideal angular velocity so that the PWM amplifier adjusts the current angular velocity of the rotor according to the calibration signal.

Further provided is a robot. The robot may comprise a body and an MCU. The body of the robot may comprise a motor and a driver. The motor may be electrically connected with to driver, and may comprise a PWM amplifier and a rotor. The MCU may be configured in the motor, and may be electrically connected with the PWM amplifier and the driver respectively. The MCU may comprise two Hall sensors and a calibration module electrically connected with the two Hall sensors. The two Hall sensors may be configured to sense a magnetic field of the rotor and generate two voltage signals. The calibration module may be configured to receive a pulse signal from the driver, and calculate an ideal angular velocity of the rotor according to the pulse signal. Moreover, the calibration module may further be configured to calculate a current angular velocity of the rotor based on the two voltage signals, and transmit a calibration signal to the PWM amplifier according to a difference of the current angular velocity and the ideal angular velocity so that the PWM amplifier adjusts the current angular velocity of the rotor according to the calibration signal, therefore adjusting an action of the robot.

As described above, the MCU is capable of sensing the magnetic field of the rotor of the motor by itself and directly transmitting a calibration signal to the PWM amplifier of the motor. Therefore, the MCU, instead of the driver, plays the role of performing a rotation compensation to the motor, and it can perform such rotation compensation without interventions of a central control computer. Hence, the transmission delay between the conventional driver and the central control computer can be avoided. On the other hand, because the MCU is configured in the motor, the transmission path between the MCU and the motor is shorter than that between the conventional driver and the motor, and therefore, the transmission delay between the MCU and the motor is shorter than the transmission delay between the conventional driver and the motor. Thus, the rotation compensation to the motor can be performed more instantaneously, and the efficiency of the rotation compensation to the motor can be effectively improved. The aforesaid content is not intended to limit the present invention, but merely describes the technical problems that can be solved by the present invention, the technical means that can be adopted, and the technical effects that can be achieved, so that people having ordinary skill in the art can basically understand the present invention. People having ordinary skill in the art can understand the various embodiments of the present invention according to the attached drawings and the content recited in the following embodiments.

### BRIEF DESCRIPTION OF THE DRAWINGS

The drawings are provided for describing various embodiments, in which:

FIG. 1A illustrates a motor according to one or more embodiments of the present invention;

FIG. 1B illustrates a robot according to one or more embodiments of the present invention;

FIG. 2A illustrates a top view of a motor's rotor and Hall sensors according to one or more embodiments of the present invention;

FIG. 2B illustrates a side view of the motor's rotor and Hall sensors shown in FIG. 2A; and

FIG. 3 illustrates a method for calibrating an angular velocity of a motor according to one or more embodiments of the present invention.

### DETAILED DESCRIPTION

The exemplary embodiments described below are not intended to limit the present invention to any specific example, embodiment, environment, applications, structures, processes or steps as described in these exemplary embodiments. In the attached figures, elements not directly related to the present invention are omitted from depiction. In the attached figures, dimensional relationships among individual elements in the attached drawings are merely examples but not to limit the actual scale. Unless otherwise described, the same (or similar) element symbols may correspond to the same (or similar) elements in the following description. Unless otherwise described, the number of each element described below may be one or more under implementable circumstances.

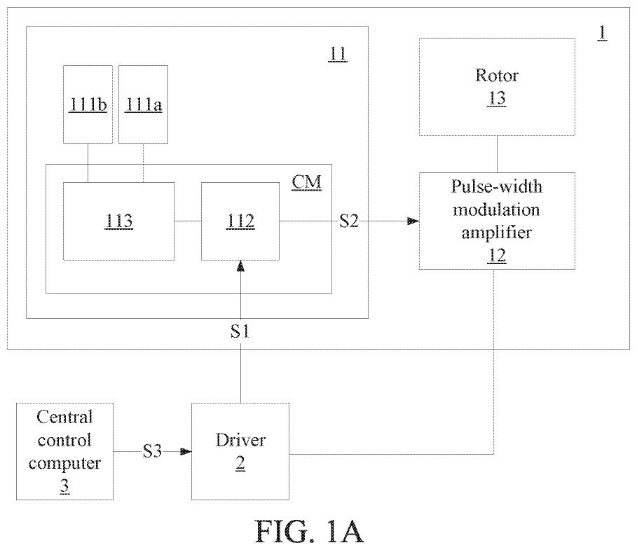

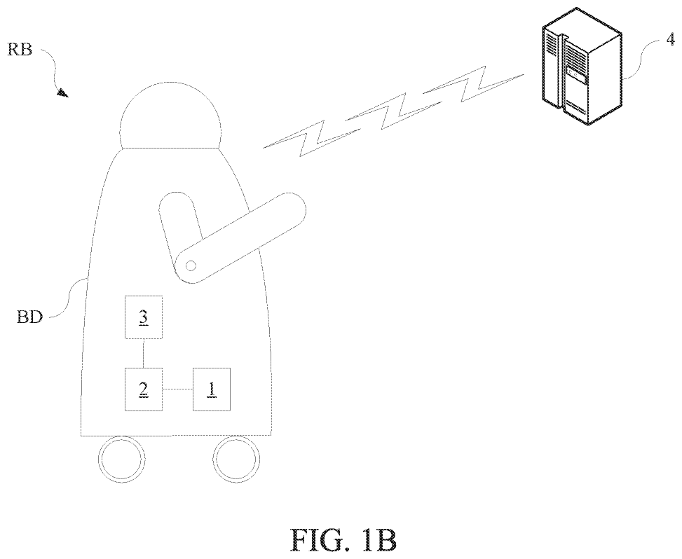

FIG. 1A illustrates a motor according to one or more embodiments of the present invention. The contents of FIG. 1A are shown merely for explaining the embodiments of the present invention instead of limiting the present invention.

Referring to FIG. 1A, a motor 1 may be one of various types of motors, such as a brushless direct current (BLDC) motor, a servo motor, a step motor, or the like. Since the basic structures of various types of motors 1 are known to the people having ordinary skills in the art, elements of the motor 1 that are not directly related to the embodiments of the present invention will not be specifically described in this disclosure and the drawings. The motor 1 may basically comprise a pulse-width modulation (PWM) amplifier 12 and a rotor 13 electrically connected with the PWM amplifier 12. The rotor 13 may rotate around a stator of the motor 1, and the PWM amplifier 12 may be configured to generate voltage signals with different pulse widths for the rotation control of the rotor 13.

The driver 2 is merely configured to control the rotation of the motor 1 (i.e., rotation control). Specifically, the driver 2 is electrically connected with the PWM amplifier 12, and may transmit control signals to the PWM amplifier 12 to command the PWM amplifier 12 to control the rotation of the rotor 13, thereby driving the motor 1. In some embodiments, for smart operations, the driver 2 may perform rotation controls to the motor 1 in accordance with the commands of a central control computer 3. The central control computer 13 may at least comprise a processor and a memory for processing and storing data, which may generate the commands by itself and/or process other commands received from outside.

FIG. 1B illustrates a robot according to one or more embodiments of the present invention. The contents of FIG. 1B are shown merely for explaining the embodiments of the present invention instead of limiting the present invention.

Referring to FIG. 1A and FIG. 1B together, in some embodiments, the motor 1, the driver 2, and the central control computer 3 may be disposed in a body BD of a robot RB, and the motor 1, the driver 2, and the central control computer 3 may cooperate so that the body BD performs various actions. In some embodiments, the central control computer 3 of the robot RB may be connected with a cloud integration platform 4 via a wired network or a wireless network so as to perform various interactions with the cloud integration platform 4. For example, if the robot RB is a service robot in places such as restaurants, hotel lobbies, airports, or the like, the cloud integration platform 4 may transmit commands to the central control computer 3 of the robot RB to ask the robot RB to perform various corresponding actions of services, and may receive the feedback data from the central control computer 3 of the robot RB. In some embodiments, other than robots, the motor 1, the driver 2, and the central control computer 3 may alternatively be configured in a land vehicle, a marine vehicle, an aircraft or any other device that includes a motor.

Whether the rotation control to the motor 1 is accurate or not directly affects the quality of the motor 1, thereby limiting its applications. For example, if the rotation control to the motor 1 is not accurate enough, it may not be applicable to a service robot or a robot required to operate precisely. The rotation control to the motor 1 includes the angular velocity control of the rotor 13, while the MCU 11 can immediately perform rotation compensation to the rotor 13 of the motor 1 whenever the angular velocity of the rotor 13 is not as expected.

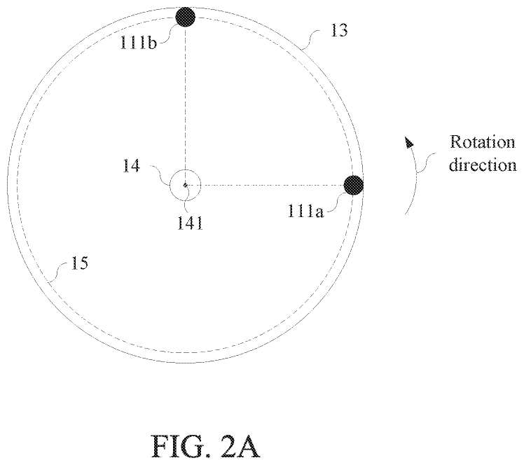

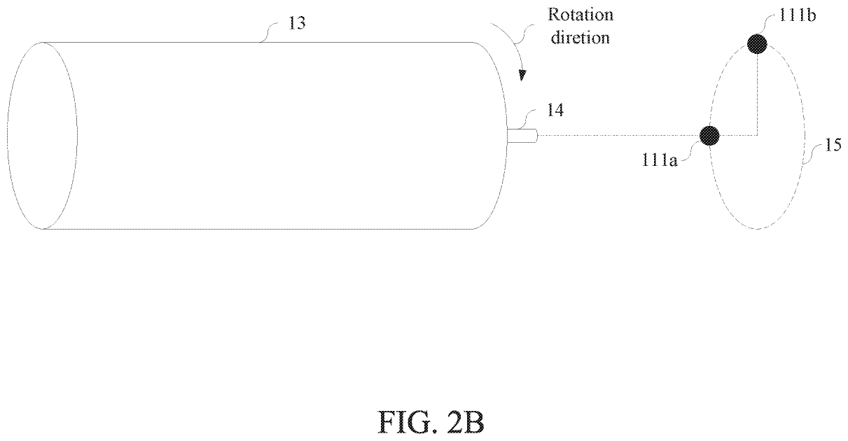

FIG. 2A illustrates a top view of a motor's rotor and Hall sensors according to one or more embodiments of the present invention. FIG. 2B illustrates a side view of the motor's rotor and Hall sensors shown in FIG. 2A. The contents of FIG. 2A and FIG. 2B are shown merely for explaining the embodiments of the present invention instead of limiting the present invention.

Referring to FIG. 1A, FIG.2A, and FIG. 2B together, the MCU 11 is configured in the motor 1 (for example, it is physically connected to the inside of the housing of the motor 1 or its internal components), and is electrically connected with the driver 2 and the PWM amplifier 12 respectively. It is useful to substitute that the MCU 11 controls the PWM amplifier 12 to perform rotation compensations to the rotor 13 for that the driver 2 do the same, because the efficiency and the accuracy both can be enhanced.

Specifically, in some embodiments, the MCU 11 may include two Hall sensors 111a and 111b and a calibration module CM electrically connected with the Hall sensors 111a and 111b. The Hall sensors 111a and 111b each may be used to sense a magnetic field of the rotor 13, and they may generate two voltage signals through a magnetic-electric signal conversion. In some embodiments, during the conversion of the magnetic-electric signal, noise may be filtered from the two voltage signals by a filter.

Taking FIG. 2A and FIG. 2B as examples, the Hall sensors 111a and 111b may be positioned in the MCU 11 forward a zero-degree position and a ninety-degree position of a rotation plane 15 of the motor 1 respectively, and the rotation plane 15 may be a circular plane with a center at an extension of an axis 141 of a bearing 14 of the motor 1 and formed when the bearing 14 rotates. The zero-degree position and the ninety-degree position are two points at the circumference of the circular plane whose center intersects with the extension of the axis 141 of the bearing 14 of the motor 1. In addition, both the rotation direction and the angular velocity of the bearing 14 substantially coincide with the rotation direction and the angular velocity of the rotor 13. In some embodiments, the Hall sensors 111a and 111b may be positioned in the MCU 11 toward any two positions of the rotation plane 15 of the motor 1 which have an angle difference of 90 degrees.

In some embodiments, the calibration module CM may comprise a bifrequency magnetic module 112 and a bipolar magnetic module 113. The bipolar magnetic module 113 is electrically connected with the bifrequency magnetic module 112 and the Hall sensors 111a and 111b, respectively. Since the Hall sensors 111a and 111b are respectively located at the zero-degree position and the ninety-degree position, the bipolar magnetic module 113 may utilize the orthogonal relationship between the positions of the Hall sensors 111a and 111b to calculate a phase difference between the two voltage signals generated by the Hall sensors 111a and 111b, and generate a phase difference signal according to the phase difference.

In some embodiments, the bipolar magnetic module 113 may also perform a method of adjustment and analysis with high frequency to analyze whether the phase difference signal is abnormal. In some embodiments, the bipolar magnetic module 113 may also normalize the phase difference signal to ensure that the value of the phase difference signal is between 0 volts and 5 volts.

After the bipolar magnetic module 113 generates the phase difference signal based on the voltage signals, the bifrequency magnetic module 112 may perform a coordinate transformation to the phase difference signal to calculate a current angular velocity of the rotor 13. For example, when an “N-pole” of the rotor 13 is rotated to the zero-degree position, the voltage generated by the Hall sensor 111a at the zero-degree position will be an upper limit voltage (e.g., 5 volts) because of stronger sensing magnetic field, and the voltage generated by the Hall sensor 111b at the ninety degree position will be smaller (e.g., 2.5 volts) because of weaker sensing magnetic field. At this time, the bifrequency magnetic module 112 may determine that the “N-pole” of the rotor 13 is currently at the zero-degree position according to the phase difference between the voltage signals of the two Hall sensors 111a and 111b. Therefore, after the coordinate transformation, the bifrequency magnetic module 112 may calculate the current angle of the rotor 13. Then, based on multiple current angles of the rotor 13 calculated at different time points, the bifrequency magnetic module 112 may calculate the current angular velocity of the rotor 13.

In some embodiments, the bifrequency magnetic module 112 may also transmit the current angular velocity of the rotor 13 to the cloud integration platform 4 through the central control computer 3.

In addition to calculating the current angular velocity of the rotor 13, the bifrequency magnetic module 112 may also receive a pulse signal S1 from the driver 2, and calculate an ideal angular velocity of the rotor 13 based on the pulse signal S1. In some embodiments, the central control computer 3 may provide the ideal-angular-velocity command S3 to the driver 2 to notify the driver 2 of an ideal value of the angular velocity of the rotor 13. The driver 2 may use a pulse converter to generate the pulse signal S1 according to the ideal value, and transmit the pulse signal S1 to the bifrequency magnetic module 112. In some embodiments, the ideal-angular-velocity command S3 may be generated based on an action command from the cloud integration platform 4. In other words, a user or manager may require a specific action or a service (including at least one action), and the central control computer 3 may accordingly generate a corresponding ideal-angular-velocity command S3.

After obtaining the current angular velocity and the ideal angular velocity of the rotor 13, the bifrequency magnetic module 112 may transmit the calibration signal S2 to the PWM amplifier 12 according to the difference between the current angular velocity and the ideal angular velocity. For example, the bifrequency magnetic module 112 may generate the calibration signal S2 by using a known lead-lag compensator according to the difference between the current angular velocity and the ideal angular velocity. Then, the PWM amplifier 12 may change the voltage of the motor 1 according to the calibration signal S2, thereby adjusting the current angular velocity of the rotor 13 (i.e., rotation compensation).

Through the instant rotation compensation to the motor 1 as mentioned above, all of the actions of the body BD of the robot RB shown in FIG. 1B can be adjusted or compensated immediately, and thus performed in a predictable and accurate way.

In some embodiments, the bifrequency magnetic module 112 may also transmit the adjusted current angular velocity to the cloud integration platform 4 through the central control computer 3.

In some embodiments, the cloud integration platform 4 may provide a graphical user interface (GUI) to allow a user or manager to control the central control computer 3 of the robot RB through the cloud integration platform 4 so as to perform various interactions with the robot RB.

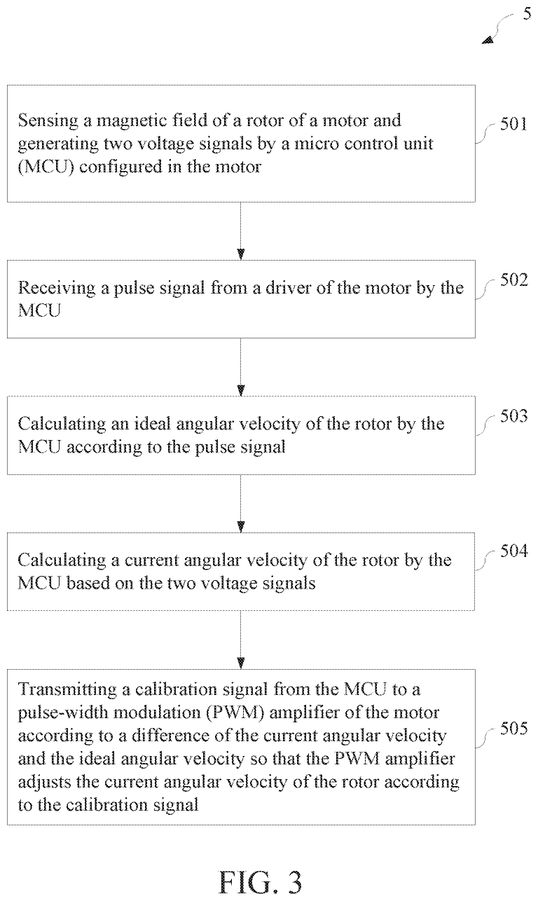

FIG. 3 illustrates a method for calibrating an angular velocity of a motor according to one or more embodiments of the present invention. The contents of FIG. 3 are shown merely for explaining the embodiments of the present invention instead of limiting the present invention.

Referring to FIG. 3, a method 5 for calibrating an angular velocity of a motor may comprise the following steps:

sensing a magnetic field of a rotor of the motor and generating two voltage signals by a micro control unit (MCU) configured in the motor (marked as 501);

receiving a pulse signal from a driver of the motor by the MCU (marked as 502);

calculating an ideal angular velocity of the rotor by the MCU according to the pulse signal (marked as 503);

calculating a current angular velocity of the rotor by the MCU based on the two voltage signals (marked as 504); and

transmitting a calibration signal from the MCU to a pulse-width modulation (PWM) amplifier of the motor according to a difference of the current angular velocity and the ideal angular velocity so that the PWM amplifier adjusts the current angular velocity of the rotor according to the calibration signal (marked as 505).

The order of steps shown in FIG. 3 is not a limitation, and it may be arbitrarily adjusted as long as method 5 for calibrating the angular velocity of the motor can be implemented.

In some embodiments, regarding the method 5 for calibrating the angular velocity of the motor, the MCU may sense a magnetic field of the rotor with two Hall sensors. In addition, the two Hall sensors are positioned in the MCU toward a zero-degree position and a ninety-degree position of a rotation plane of the motor respectively, and the rotation plane is a circular plane with a center at an extension of an axis of a bearing of the motor and formed when the bearing rotates.

In some embodiments, the method 5 for calibrating the angular velocity of the motor may further comprise the following steps:

generating a phase-difference signal by the MCU according to a phase difference of the two voltage signals; and

performing a coordinate transformation to the phase-difference signal by the MCU to calculate the current angular velocity.

In some embodiments, regarding the method 5 for calibrating the angular velocity of the motor, the MCU may generate the calibration signal with a lead-lag compensator.

In some embodiments, regarding the method 5 for calibrating the angular velocity of the motor, the PWM amplifier may adjust the current angular velocity by changing a voltage of the motor according to the calibration signal.

In addition to the above embodiments, the method 5 for calibrating the angular velocity of the motor may also comprise other embodiments corresponding to those of the of the motor 1 as mentioned above. Since the embodiments of the method 5 for calibrating the angular velocity of the motor which are not mentioned specifically can be directly understood by people having ordinary skills in the art according to the description for the motor 1 above, they will not be further described herein.

The above disclosure is related to the detailed technical contents and inventive features thereof. People of ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A micro control unit (MCU) for calibrating an angular velocity of a motor, the MCU being configured in the motor comprising a pulse-width modulation (PWM) amplifier and a rotor, the MCU being electrically connected with the PWM amplifier and a driver electrically connected with the PWM amplifier respectively, and the MCU comprising:
two Hall sensors, configured to sense a magnetic field of the rotor and generate two voltage signals; and
a calibration module, electrically connected with the two Hall sensors and configured to:
receive a pulse signal from the driver;
calculate an ideal angular velocity of the rotor according to the pulse signal;
calculate a current angular velocity of the rotor based on the two voltage signals; and
transmit a calibration signal to the PWM amplifier according to a difference of the current angular velocity and the ideal angular velocity so that the PWM amplifier adjusts the current angular velocity of the rotor according to the calibration signal.

2. The MCU of claim 1, wherein the two Hall sensors are positioned in the MCU toward a zero-degree position and a ninety-degree position of a rotation plane of the motor respectively, and the rotation plane is a circular plane with a center at an extension of an axis of a bearing of the motor and formed when the bearing rotates.

3. The MCU of claim 1, wherein the calibration module is further configured to:
generate a phase-difference signal according to a phase difference of the two voltage signals; and
perform a coordinate transformation to the phase-difference signal to calculate the current angular velocity.

4. The MCU of claim 1, wherein the calibration module generates the calibration signal with a lead-lag compensator.

5. The MCU of claim 1, wherein the PWM amplifier adjusts the current angular velocity by changing a voltage of the motor according to the calibration signal.

6. A method for calibrating an angular velocity of a motor, comprising:
sensing a magnetic field of a rotor of the motor and generating two voltage signals by a micro control unit (MCU) configured in the motor;
receiving a pulse signal from a driver of the motor by the MCU;
calculating an ideal angular velocity of the rotor by the MCU according to the pulse signal;
calculating a current angular velocity of the rotor by the MCU based on the two voltage signals; and
transmitting a calibration signal from the MCU to a pulse-width modulation (PWM) amplifier of the motor according to a difference of the current angular velocity and the ideal angular velocity so that the PWM amplifier adjusts the current angular velocity of the rotor according to the calibration signal.

7. The method of claim 6, wherein:
the MCU senses the magnetic field of the rotor with two Hall sensors; and
the two Hall sensors are positioned in the MCU toward a zero-degree position and a ninety-degree position of a rotation plane of the motor respectively, and the rotation plane is a circular plane with a center at an extension of an axis of a bearing of the motor and formed when the bearing rotates.

8. The method of claim 6, further comprising:
generating a phase-difference signal by the MCU according to a phase difference of the two voltage signals; and
performing a coordinate transformation to the phase-difference signal by the MCU to calculate the current angular velocity.

9. The method of claim 6, wherein the MCU generates the calibration signal with a lead-lag compensator.

10. The method of claim 6, wherein the PWM amplifier adjusts the current angular velocity by changing a voltage of the motor according to the calibration signal.

11. A robot, comprising:
a body, comprising a motor and a driver, the motor comprising a pulse-width modulation (PWM) amplifier and a rotor, the PWM amplifier being electrically connected with the driver;
a micro control unit (MCU) configured in the motor, being electrically connected with the PWM amplifier and the driver respectively and comprising:
two Hall sensors, configured to sense a magnetic field of the rotor and generate two voltage signals; and
a calibration module, electrically connected with the two Hall sensors and configured to:
receive a pulse signal from the driver;
calculate an ideal angular velocity of the rotor according to the pulse signal;
calculate a current angular velocity of the rotor based on the two voltage signals; and
transmit a calibration signal to the PWM amplifier according to a difference of the current angular velocity and the ideal angular velocity so that the PWM amplifier adjusts the current angular velocity of the rotor according to the calibration signal, therefore adjusting an action of the robot.

12. The robot of claim 11, wherein the body of the robot further comprises a central control computer, and wherein:
the central control computer is electrically connected with the driver and configured to provide an ideal-angular-velocity command; and
the driver is further configured to transmit the pulse signal to the calibration module according to the ideal-angular-velocity command.

13. The robot of claim 12, wherein the central control computer is connected with a cloud integration platform via a network so as to interact with the cloud integration platform.
